(19) United States
(12) Patent Application Publication
(10) Pub. No.: US 2014/0136446 A1
(43) Pub. Date: May 15, 2014

(54) METHOD AND COMPUTER READABLE MEDIUM FOR MANAGING INVESTMENT PORTFOLIOS

(71) Applicants: Ronen Golan, Tel-Aviv (IL); Nechemia Bor, Jerusalem (IL)

(72) Inventors: Ronen Golan, Tel-Aviv (IL); Nechemia Bor, Jerusalem (IL)

(21) Appl. No.: 13/855,012

(22) Filed: Apr. 2, 2013

Related U.S. Application Data
(60) Provisional application No. 61/619,583, filed on Apr. 3, 2012.

(51) Int. Cl. G06Q 40/06

(52) U.S. Cl. CPC G06Q 40/06
USPC 705/36 R

(57) ABSTRACT

A method and a non-transitory computer readable medium, the method includes receiving by a computerized system information about a large number of investment opportunities; wherein each investment opportunity exhibits investment characteristics and is formed from a financial asset; comparing in real time, by the computerized system, between characteristics of investment opportunities and characteristics of a large amount of investment portfolios to find investment opportunities that match investment portfolios; and adding investment opportunities to investment portfolios that match the investment opportunities

### RELATED APPLICATIONS

This application claims priority from U.S. provisional patent Ser. No. 61/619,583 filing date Apr. 3, 2012 that is incorporated herein by reference.

### BACKGROUND

The policy of managing investment portfolios of any sort (e.g. IRA) by Banks, Insurance Firms, Investment Houses and the like, is based on selling “financial products” to their clients. These “financial products”, are basically “reference” portfolios, with varying characteristics (mix, risk degrees, etc.) which are being market to clients/investors, as products their money will be invested in. This policy is used for practical reason (among other reasons). The policy allows managing in practice only few portfolios, which serve numerous clients. As a result, Investment Houses, for example, can refrain from managing thousands of personal portfolios with thousands of different characteristics for each client individually. The “Reference Portfolios” is managed in a long-term, mid-term, or short-term view (as opposed to a dynamic daily, weekly or monthly view) and usually is characterized with low activity within it. The investor usually suffers from an impersonal portfolio that in most cases does not answer his personal needs.

Since the year 2000, financial market behavior changed dramatically, and became much more fluctuated. As a result, market trends do not show the monotonic increase they used to. Consequently, the common approach that the market will continue its increasing trend, and thus will yield positive returns is no longer valid. As a matter of fact, it appears that during the past few years, investment portfolios yielded low returns, if any. At the same time, IT technologies improved dramatically, along with numerous tools for on-line direct trading of financial instruments over trading platforms supplied by Banks, Brokers and others.

Due to these changes, the number of investors, managing their investment portfolios by themselves, increased. The main reasons for that were: (1) to be able to manage a more active trading strategy; and (2) to manage a more personalized portfolio and (3) avoid high commissions to portfolio managers and advisors.

In spite of numerous solutions and tools available today for end users, there is a server shortage in tools supporting investors from a portfolio management point of view. Most solutions centralize around online trading in real time rather than managing a portfolio for the long run. They mostly provide tools for opportunities analysis, information analysis and supplying information in real time.

Moreover, in a highly dynamic financial market, there is a need for detecting large amounts of opportunities for investments. This need require the development of tools for collecting all the opportunities and managing them from a single location.

The present invention includes several innovations allowing a centralized management of “Opened Positions” and “On-Hold Positions” (e.g. opportunities).

### SUMMARY

According to embodiments of the invention various methods, non-transitory computer readable media and systems may be provided and are described in the specification.

According to an embodiment of the invention there may be provided a computerized method for managing investment portfolios that may include receiving by a computerized system information about a large number of investment opportunities; wherein each investment opportunity exhibits investment characteristics and is formed from a financial asset; comparing in real time, by the computerized system, between characteristics of investment opportunities and characteristics of a large amount of investment portfolios to find investment opportunities that match investment portfolios; and adding investment opportunities to investment portfolios that match the investment opportunities.

The managing of the investment portfolios comprises determining an amount of financial assets transactions based upon characteristics of the investment portfolio.

The computerized method may include adding an investment opportunity to an investment portfolio if the investment portfolio has available cash to purchase the financial asset that forms the investment opportunity.

The computerized method may include adding an investment opportunity to an investment portfolio if the investment portfolio has a financial asset that is less attractive than the financial asset that forms the investment opportunity.

The computerized method may include constantly monitoring characteristics of financial assets that form the investment portfolios.

The computerized method may include monitoring characteristics of financial assets that belong to investment portfolios and removing financial assets from investment profiles if it is detected that characteristics of the financial assets changed and do not match the characteristics of the investment profiles.

The computerized method may include generating aggregate purchase orders, each aggregate purchase order is for purchasing financial assets required for multiple investment portfolios that include the financial asset; receiving the multiple financial assets; and splitting the multiple financial assets between the multiple investment portfolios.

The computerized method may include calculating at least one characteristic of a financial asset in response to an investment portfolio that includes the financial asset.

The computerized method may include evaluating a profit loss ratios of financial assets that belong to investment portfolios and of financial assets that form investment opportunities and replacing a first financial asset that belongs to an investment portfolio by a second financial asset that forms an investment opportunities if a profit loss ratio of the first financial asses is lower than a profit loss ratio of the second financial asset by at least a predetermined amount.

The computerized method may include deploying a leverage option provided by a broker.

The computerized method may include calculating a risk level of at least one financial asset by multiplying a risk factor of the at least one financial asset by a leverage factor of the at least one financial asset.

The computerized method may include finding financial assets to be included in financial assets.

According to an embodiment of the invention there may be provided a non-transitory computer readable medium that stores instructions for receiving by a computerized system information about a large number of investment opportunities; wherein each investment opportunity exhibits investment characteristics and is formed from a financial asset; comparing in real time, by the computerized system, between characteristics of investment opportunities and characteristics of a large amount of investment portfolios to find investment opportunities that match investment portfolios; and adding investment opportunities to investment portfolios that match the investment opportunities.

The non-transitory computer readable medium may store instructions for adding an investment opportunity to an investment portfolio if the investment portfolio has available cash to purchase the financial asset that forms the investment opportunity.

The non-transitory computer readable medium may store instructions for adding an investment opportunity to an investment portfolio if the investment portfolio has a financial asset that is less attractive than the financial asset that forms the investment opportunity.

The non-transitory computer readable medium may store instructions for constantly monitoring characteristics of financial assets that form the investment portfolios.

The non-transitory computer readable medium may store instructions for monitoring characteristics of financial assets that belong to investment portfolios and removing financial assets from investment profiles if it is detected that characteristics of the financial assets changed and do not match the characteristics of the investment profiles.

The non-transitory computer readable medium may store instructions for generating aggregate purchase orders, each aggregate purchase order is for purchasing financial assets required for multiple investment portfolios that include the financial asset; receiving the multiple financial assets; and splitting the multiple financial assets between the multiple investment portfolios.

The non-transitory computer readable medium may store instructions for calculating at least one characteristic of a financial asset in response to an investment portfolio that includes the financial asset.

The non-transitory computer readable medium may store instructions for evaluating a profit loss ratios of financial assets that belong to investment portfolios and of financial assets that form investment opportunities and replacing a first financial asset that belongs to an investment portfolio by a second financial asset that forms an investment opportunities if a profit loss ratio of the first financial asses is lower than a profit loss ratio of the second financial asset by at least a predetermined amount.

The non-transitory computer readable medium may store instructions for deploying a leverage option provided by a broker.

The non-transitory computer readable medium may store instructions for calculating a risk level of at least one financial asset by multiplying a risk factor of the at least one financial asset by a leverage factor of the at least one financial asset.

The non-transitory computer readable medium may store instructions for finding financial assets to be included in financial assets.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a system according to an embodiment of the invention;

FIG. 2 illustrates data structures according to an embodiment of the invention;

FIG. 3 illustrates data structures according to an embodiment of the invention;

FIG. 4 illustrates a method according to an embodiment of the invention; and

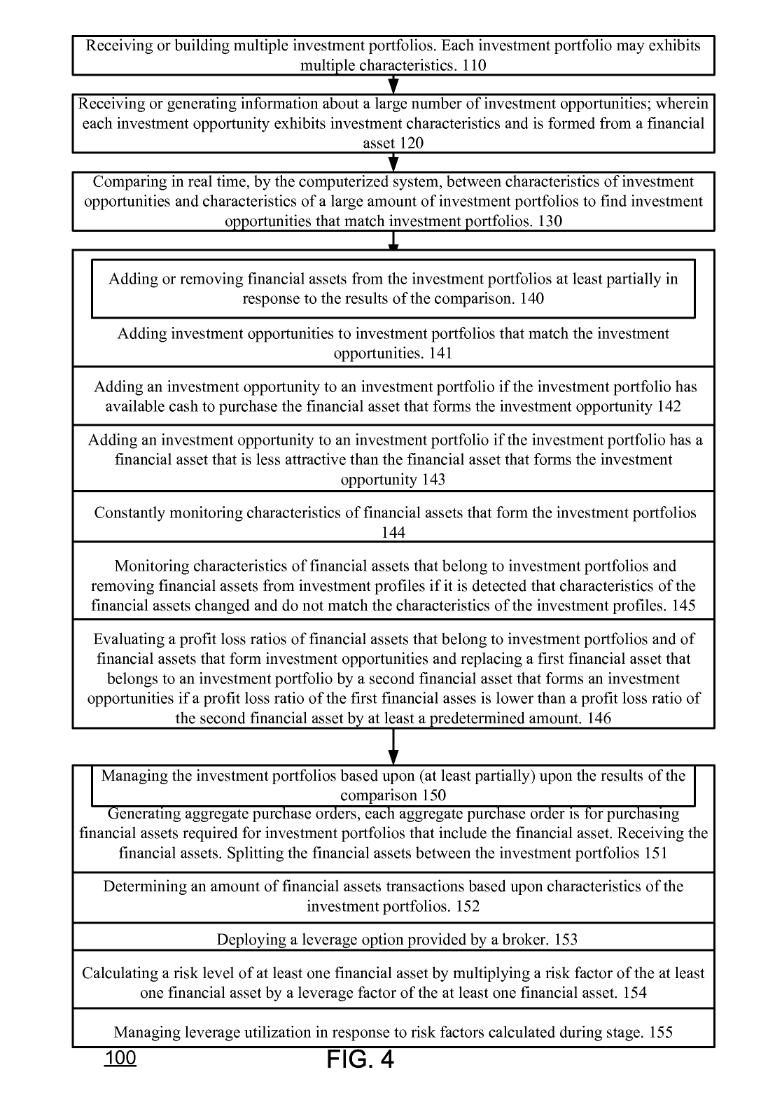

FIG. 5 illustrates a method according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The terms “large number”, numerous should mean 100, 1000, 10000, 100000 and even more.

In order to manage numerous investment portfolios with different policies and characteristics, there is a need to replace the “Reference Portfolio” approach with a new one.

There is provided a system that supports has the ability to disseminate automatically financial assets from the “pool” to unlimited number of portfolios based on the policy of each portfolio and based on the trading strategy of the asset in the “pool”.

There is provided a system that has the ability to manage simultaneously portfolio (based on its policy and characteristics) and trading strategy of each position (financial asset) in the portfolio.

The system may have the ability to monitor the financial assets in the “pool” before they are assigned to portfolios.

The system may provide a centralized and supervised surrounding for managing unlimited number of opened positions. The system may be arranged to manage trades in view of a general policy, as well as managing an overall budget, mix management, etc. The system may also be able to manage unlimited number of portfolios, each with a different policy and characteristics from one central place.

In order to manage unlimited number of investment portfolios with different characteristics, there is a tremendous importance to be able to manage a centralized and updated repository of optional positions, reflecting the varying investment opportunities. Moreover, there is a great deal of importance in monitoring, in real time, numerous amounts of positions. This type of monitoring is humanly impossible without some sort of computerized tools dedicated for this purpose.

The tool should be able to hold unlimited number of “On-Hold Positions”, identify the entry point for each position, examine in real time all active portfolios and their characteristics testing for adequacy, deciding on the buying amount, and only then assign the “on-hold position” to the appropriate portfolios automatically, based on the active portfolios' profiles. The present invention enables the implementation of all of the above.

The present invention offers solutions to the following problems and difficulties:

Inability to accumulate an unlimited number of “On-Hold Positions” simultaneously, by a single user or multiple users, as well as holding the trading policy (strategy) with high degree of complexity, for each position;

Inability to manage numerous numbers of opportunities simultaneously. By managing we mean, for example, the ability to monitor whether each opportunity is in agreement with the overall policy of the repository; or, for example, the ability to test for logical inadequacies, or testing for the overall risk management policy of the repository;

Inability to disseminate, in real time, “On-Hold Positions” from the repository (i.e. POOL) to multiple active portfolios, each with different investment policy. This limitation includes also an adequacy testing of each position in the POOL to the active portfolio, based on its characteristics, whether predefined or automatically deducted, using machine learning algorithms.

Inability to react, in real time, to changes in a dynamic market environment.

Inability to keep on searching and finding new opportunities that are in-line with the overall policy of the repository (e.g. the POOL).

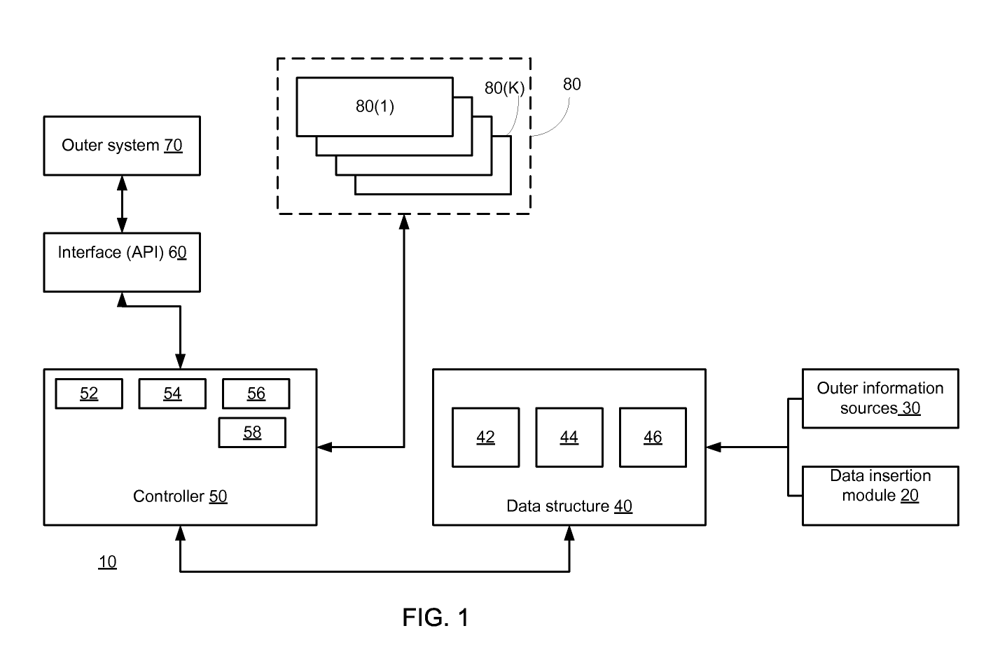

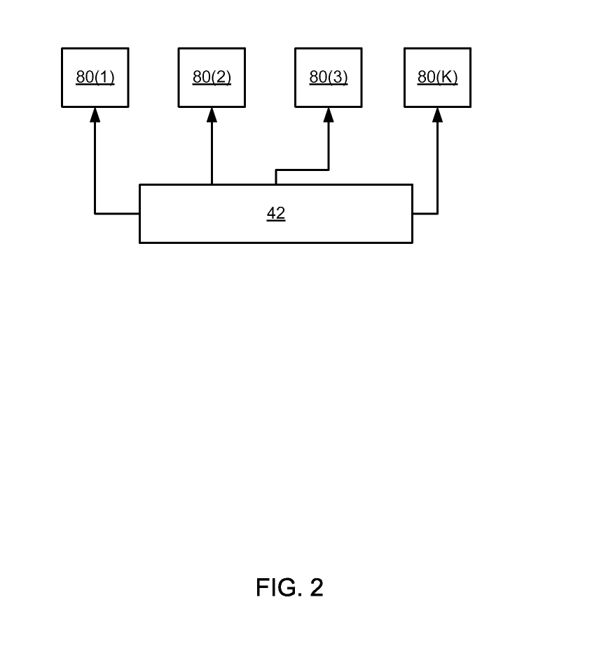

There may be provided a system that may include:
a. A data structure such as a table (denoted 42 in FIG. 2 and part of database 40 of FIG. 1), or any other mean, for holding numerous numbers of opportunities (“On-Hold Positions”). As well as holding numerous numbers of characteristics determining the policy or strategy for each position. Characteristics can be entered manually or automatically by applying machine learning algorithms. An example for a set of characteristics could be the entry price of the financial instrument, the selling price, stop lose, first and second execution prices, trading volume limitations, risk ratio, and the like. These are only examples for a wide variety of characteristics;
b. A back-office module (denoted “data insertion module 20 in FIG. 1) for entering characteristics for each “On-Hold Positions”. The module includes but is not limited to the following features—classifying the sector for each position; setting the risk level for each position;
c. A controller (also referred to as “decision making support system 50 in FIG. 1), for monitoring inconsistencies. For example logical inconsistencies that are not in agreement with the overall policy
d. A table, or any other mean, for holding and managing active portfolios (denoted 80 and 80(1)-80(K) in FIGS. 1 and 80(1)-80(K) of FIG. 2). The table includes the overall profile and policy of the investor: e.g. budget, risk, mix, segments, gain/loss ratio, relative weight of each active position and the like. The profile can be determined manually or automatically by applying machine learning algorithms;
e. A table or any other mean, for holding A-priori special conditions for entering a position (this may be a part 44 of database 40 of FIG. 1), specified by the user or by applying machine learning algorithms.
f. A control and monitoring module (denoted 52 in FIG. 1) for automatic dissemination of “On-Hold Positions” to active portfolios, in real time, while checking for adequacy to the specific profile of each active portfolio. For example, in case where a specific active portfolio holds an overall policy that includes stocks with low risk, and an “On-Hold Positions”, classified as a low risk stock, reaches its entering price, the “On-Hold Positions” will be disseminated to the specific active portfolio. On the other hand, if, for example, the “On-Hold Positions” is associated with the “bio-tech” sector, and active portfolio does not hold “bio-tech” stocks in its segments definitions, then the “On-Hold Positions” will not be disseminated to the active portfolio, even when reaching its entry price.
g. A module that enables characteristics adjustment (denoted 55 in FIG. 1 of an “On-Hold Positions” to the specific policy and characteristics of an active portfolios. For example, the module can determine the amount of stocks to buy based on the characteristics of the active portfolio; or, for example, its relative portion in the mix.
h. An optimization module (denoted 54 in FIG. 1) for making adjustments in an active portfolio. For example, in case where an opened position should be replaced with another having better chance/risk ratio.
i. A module (Denoted 56), based on machine learning algorithms, that learns automatically the policy of the “On-Hold Positions” repository, based on existing financial assets in the repository. The module will automatically look for other financial instruments having similar characteristics.
j. An execution module (58) for executing trades. The execution module 58 can be connected via API (60) to an outer system such as a trading platform. the actual buy/sell of financial instruments is performed by the trading platform. The execution module 58 may send sell and/or buy instructions via API 60 based on policies and strategies over external trading platforms. Alternatively, the module can prompt alerts for manual executions.

The system 10 may be independent of any trading platform or subjected to a specific account.

The system includes “On-Hold Positions” for varying types of financial instruments (stocks, bonds, futures, FOREX, etc.)

Each position (financial asset) in the POOL (e.g. “On-Hold Positions” repository) can have a specific independent strategy/policy.

The POOL can serve a single active portfolio, or numerous numbers of independent active portfolios, each with its own account, policy and characteristics.

The POOL can be accessed either by the owner of the account or by multiple approved users (such as investment advisors or portfolio managers).

The POOL serves as a dissemination center for all active portfolios.

The POOL holds a self-adaptive module, enabling the automatic disseminated of “On-Hold Positions” and their adjustments in accordance with the specific policies and characteristics of the active portfolios.

The platform can make use of a single POOL or multiple POOLs, each serving a different purpose.

Optimization modules, based on machine learning algorithms, for searching and recommending on available opportunities, based on active policies.

Optimization modules, based on machine learning algorithms, for managing opened positions.

The POOL can serve either a single user or multiple users. The POOL can also be single managed or co-managed by multiple users.

FIG. 2 illustrates a diagram demonstrating the dissemination of financial assets from the “On-Hold Positions” repository 42 to independent active portfolios 80(1)-80(K). Number of portfolios in not limited to the four expressed in the drawing. The repository 42 (On-Hold Positions repository)” holds numerous financial assets, each with its own independent characteristics. Portfolios 80(1)-80(K) represent independent active portfolios, each managed separately and hold an independent policy, characteristics, terms and conditions.

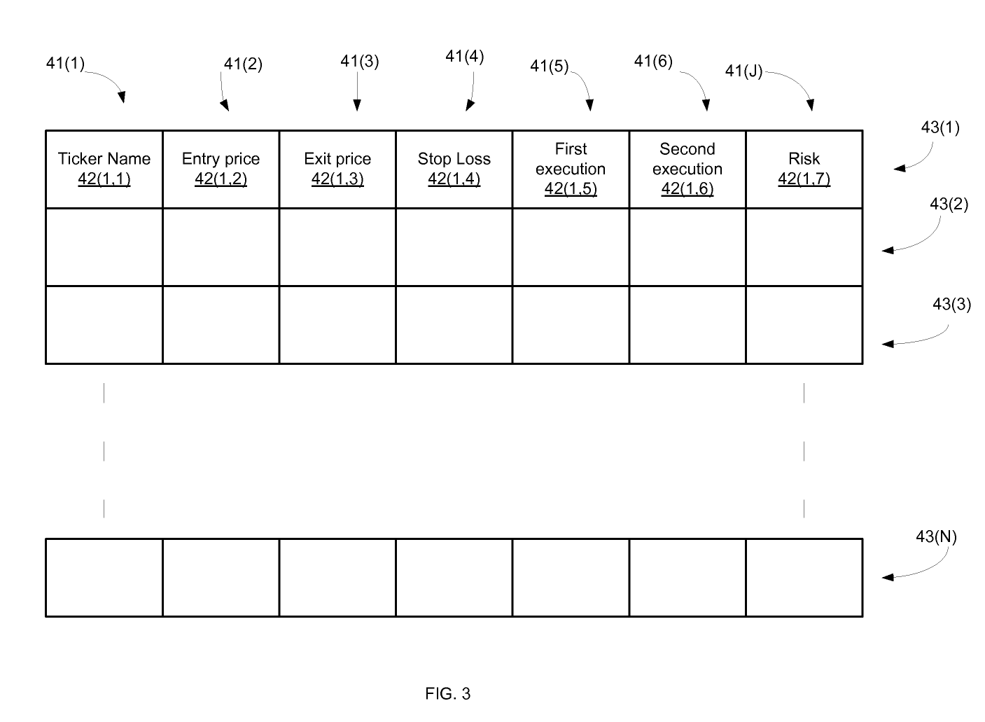

FIG. 3 is a diagram demonstrating the content of On-Hold Positions repository 42. Repository 42 includes N rows 43(1)-43(N) for storing characteristics of a large number (N−1) of investment opportunities (N may exceed 100, 1000, 10000, 100000 and even more). Repository 42 also includes J columns 41(1)-41(J) for storing up to J characteristics for each investment opportunity. The first row of the On-Hold Positions repository 42 includes multiple column headers—42(1,1)-42(1,J) each representative of a certain type of characteristic of the financial asset that forms an investment opportunity. Each row (other than the first row) lists the characteristics of a single investment opportunity.

The number and/or type of characteristics is not limited to the number of objects in the drawing or to the type of characteristic (ticker name, entry price, exit price, stop loss point/s, first execution, second execution, etc. . . . and risk).

According to an embodiment of the invention the system includes a controller 50, a repository 42 of financial opportunities (stocks, bonds, forex, futures and the like) and portfolios 80 of financial products (stocks, bonds, forex, futures and the like).

The repository 42 can contain an unlimited number of financial assets. For each financial asset a set of conditions can be determined. For example—Entry price, a set of target prices, Stop price/prices, Volume, Dates, Hours/Time, Technical conditions and the like. There is no necessity that all conditions will be entered into the repository.

These characteristics are compared in real time with the actual market data (fed from outer information sources 30).

Based on these characteristics, if matched, a financial asset may be eligible to enter into a portfolio (the second component) or a set of unlimited number of portfolios.

So for example: if the repository contain the stock of “Teva” and an entry price of 30$. Then when the market data shows that the Stock reached 30$ the financial asset is eligible to be entered into a portfolio. Otherwise it is still on hold.

Each portfolio 80 contains a set of characteristics predefined by the user (either an end user, i.e. a private investor or a professional, i.e. an advisor or a portfolio manager).

Characteristics may include: The size of the portfolio. i.e. how much money is in the portfolio (cash and invested); the overall risk of the portfolio; sectors and Industries that the portfolio may contain: e.g. Basic Materials, or Healthcare, or Financial, etc; subsectors (Industries); and the risk for each sector and sub-sector and the like.

Financial assets and their characteristics are entered into the repository 42 manually or automatically (there is an option to update some of the characteristics automatically. For example the stop loss condition can be calculated after the financial asset is assigned to a portfolio based on the characteristics of the portfolio.

Portfolio Definition

The definition of the portfolio can include receiving and/or defining portfolio characteristics that can define the portfolio, portfolio portions (Sectors, sub-sectors and even individual financial assets).

These characteristics can be used to calculate other characteristics such as stop loss rules—for the entire portfolio, for sectors, for sub-sectors and even for one or more financial assets.

The characteristics of the entire portfolio may include, for example, budget, budget per sector/per sub-sector, maximal risk level for the portfolio, sector, sub-sector, and financial asset.

Additional characteristics that can be received and/or calculated may include, for example: ratio of profit/loss for different types of financial assets; maximum relative weight of each segment position in relation to the case. (This affects the distribution of portfolio risk on an ongoing basis).

For example: the budget of an entire portfolio is 100000$ and may be divided to four segments:
a. 30% non-leveraged forex;
b. 30% BONDS;
c. 10% shares of Biotechnology companies (risk/high, long range);
d. 30% of leading shares (market value above average) or indices (S & P, Nasdaq, Dow, etc.).

Each segment is determined by risk level Fibonacci values:
a. non-leveraged Forex 5%
b. BONDS: 5%
c. BioTech: 50%
d. Stocks and Indices: 23.6%

Maximum risk level of the portfolio as a whole:

15080=(30000$*5%)+(30000$*23.6%)+(30000*5%)+(10000*50%)

In the process of characterizing the portfolio, the final result of all components of the portfolio can be provided to the user that may be required to approve it.

Each segment of the portfolio may be managed according to its rules and positions that segment will close at stop loss set forth the entire segment without having to close the other segments positions.

The definition of the portfolio may include calculating capitalization points for caching profits or stop loss points for selling the financial assets (in case of losses).

Definition of Loss Stop

The system may examine the capitalization points and stop loss points in response to the characteristics (parameters) of the predetermined risk management.

For example—an investor may select the following characteristics:
a. Overall risk level segment of the investment in shares and indices about 20% (or by the bar Fibonacci: 23.6%).
b. Minimum number of positions in this segment: 10 (distribution of risk) (A)
c. Maximum deviation of the position relative weight: up to 25% (this characteristic may be determined by a portfolio process customization/specification file.) This data is used to trigger an alert for warning the investor (user) when there is a state of equilibrium in the case and to avoid the unnecessary messages and alerts about exceptions that are part of the normal activities of the portfolio.
d. Minimum loss ratio as a prerequisite for entry position: 2:1 (gain two, lose one).
e. Budget investor segment shares and indices of $30,000 (C
f. Maximum allowable loss for this segment will be up to 23.6% (about $ 7080).
g. The portfolio should include at least 10 positions (10 financial assets)
h. The loss per each financial asset should not exceed $700 (about 7080$ divided by ten).
i. Investor wants to buy the stock Intel (INTC) entry price of $20. (B)

The system calculates the maximum number of shares under the policy set:

C/(A*B).

In this case, 150 shares should be purchased and a capitalization point of $22 (share prices) is set—which is a gain of 10% share and stop loss point gate 18.

The system checks if the data fit the portfolio risk management policy:
a. According to loss ratio of 2:1 breakpoint lowest loss could be $19. Therefore, at this stage the system will conflict with the investment policy and seek to change the stop point or destination depending on, or give up the investment in INTC.
b. The stop loss point will be examined in relation to the number of shares that are designed to be acquired does not exceed the permissible loss of $700 position. Insomuch that the stop loss point is selected in relation to the number of shares exceeds the policy, the system will alert and prompt to change or the number of shares or the point of the stop.

According to the basic data set, and a trading plan, the system can calculate the maximum stop loss point and provide the limits of investor profit taking against the stop loss.

Portfolio Management

According to an embodiment of the invention the system 10 may manage the portfolios by applying risk management techniques. The value of the portfolio can be compared (on an ongoing basis) to one or more thresholds such as a set of thresholds that form a Fibonacci bar in real time.

The span (minimum and maximum points) of a Fibonacci bar that is used to evaluate the entire investment portfolio can be defined in various manners—as the maximal value of the entire investment portfolio over time, as a maximal value of the entire investment portfolio within a predefined period, in response to one or more characteristics of the entire investment portfolio and the like.

There may be defined multiple Fibonacci bars—per sector, per sub-sector, per segment, per one or more financial assets and the like. The management may include comparing the relevant entities (sector, sub-sector, segment, one or more financial assets) to the thresholds of the relevant Fibonacci bars.

Different Fibonacci bars can be determined at the same manner or at different manners.

The value of the entire portfolio, of sectors of the portfolio, of sub-sectors and even of individual financial assets of the portfolio can be compared to the one or more thresholds of the Fibonacci bar and these comparison may trigger actions such as selling a financial asset (all of part thereof), purchasing a financial asset, selling the entire financial assets of one or more sectors, of one or more sub-sectors and even of the entire portfolio, replacing a financial asset of a portfolio by another financial asset, changing the amounts of financial assets in a portfolio and the like.

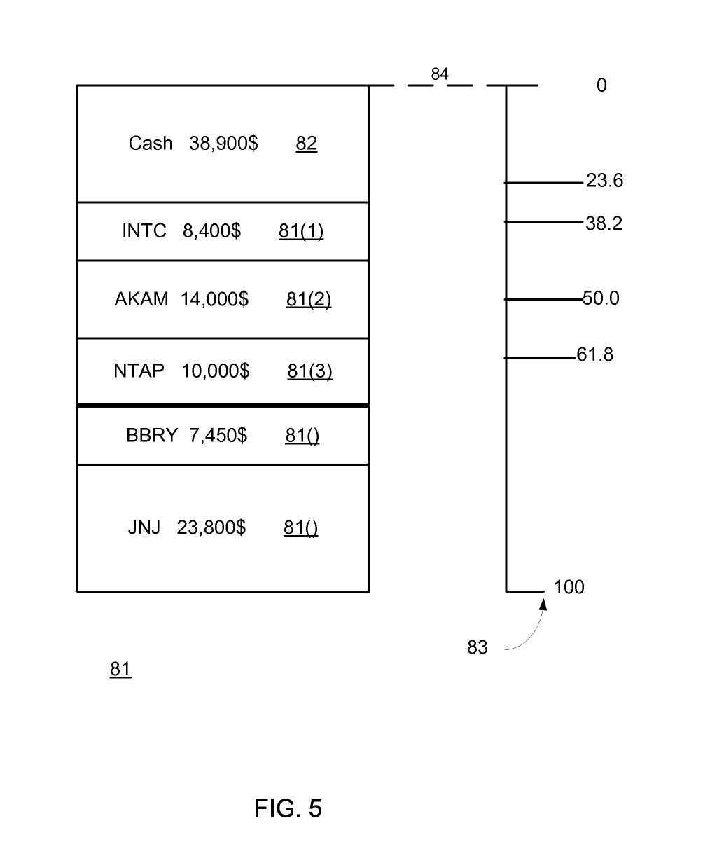

FIG. 5 illustrates a model 81 of an investment portfolio 80(1) according to an embodiment of the invention.

The investment portfolio 80(1) includes, at a certain point of time, six financial assets—five stocks (ST1-ST5) and cash (for example 38,900$). Each stock is represented in the model 81 as a rectangle—(rectangles 81(1)-81(5) represent stocks ST1-ST5). The vertical fact of each rectangle represents the value of the stock at the certain point of time.

In FIG. 5, the values of stocks ST1-ST5 are 8,400$, 14,000$, 10,000$, 7,450$ and 23,800$ respectively—total of 63,650$. The rectangles 81(1)-81(5) are stacked on each other to have an aggregate height that represents 63,650$. Rectangle 82 represents cash (38,909$).

Rectangle 82 is virtually positioned above the virtually stacked rectangles 81(1)-81(5) so that its upper facet represents the value of the entire portfolio. The upper facet also defined virtual bar 84.

The total value of portfolio 80(1) is 102,550$.

Model 81 also include a threshold set such as a Fibonacci bar 83 that has the following thresholds—0, 23.6, 38.2, 50, 61.8 and 100. The lower end of the Fibonacci bar (threshold=100) is aligned with the bottom of model 81 while the upper end of the Fibonacci bar (threshold=0) can be determined in various manners—it can, for example equal the maximal value of the investment portfolio at a certain point in time, can represent the initial investment in the portfolio and the like.

The total value of the portfolio (illustrated as bar 84) is compared to the thresholds (23.6, 38.2, 50, 61.8) of the Fibonacci bar 83 and these comparison trigger actions.

For example: when line 84 is equal to or smaller than threshold 23.6 (or equals said threshold) the system can decide to close (sell) 50% of the open positions (of the financial assets). Any attempt to enter a new position (purchase a new financial asset) when the line 84 is below threshold 23.6 (or equals said threshold) may be prevented or produce a warning. When a line 84 is below threshold 36.2 (or equals said threshold), the system can close all open positions (sell all financial assets). A closing position means selling the financial asset. Although one can insert several stop points. Alternatively, when line 84 is lower from threshold 28.2 (or equals said threshold) the system may close part of all positions and/or may generate an alert.

The mapping between threshold crossing events and action can be determined per portfolio.

The decision about the level of risk and what to do in any situation can be defined per event. The system may keep track and makes the orders automatically from pre-dictated policy.

When the portfolio is divided into different market pierced segment/sector, the system may use the number of bars Fibonacci for different risk levels appropriate for each segment and the weighted rules bar for any case.

Calculation of the Overall Portfolio Risk

The portfolio risk at any point in time or at multiple points of time may be calculated by the system.

The system may calculate the portfolio risk by calculating all open positions in the portfolio, according to its stop point, the number of units each open position and price.

The system may summarize the total exposures in all open positions and calculate the overall risk in relation to the original budget opening net bag or pulling movements with movement's deposit.

The risk level may be used to facilitate leverage utilization—a case in which the user can temporarily invest in more assets than his budget can allow.

Many trading accounts allow obtaining leverage allows the account holder to transactions beyond the amount of money (cash), the current account. (Type of credit received funding financial transactions such as buying shares for example). If the account holder chooses the option “Leveraging Optimization” system, the system will use the leverage option only if the level of risk in the portfolio will allow it.

According to an embodiment of the invention the leverage level is taken into account when calculating the risk of the entire portfolio, of sectors, of segments, of sub-sectors and financial assets. As a rule of thumb, each risk factor is calculated in response to the relevant leverage factor—if, for example, the budget of the portfolio is 100,000$ and the leverage factor is 2 (temporarily the investment is 200,000$) the risk factor of the portfolio should be doubled. The risk factor of each sector, sub-sector and financial assets should be multiplied by the leverage factor of that sector, sub-sector or financial asset.

The system calculates each time point as the overall risk level of the portfolio.

A situation a small portfolio risk level risk level limit. In this case the system will consider the use of leverage to the maximum risk level permitted by policy portfolio.

Leveraging utilization regardless of the level of risk at a given time, is increasing the risk without the owner aware portfolio. Replacing a new position open position (preferred). Since the stock movement is a dynamic variable created situations where loss ratio of a stock.

FIG. 5 illustrates method 100 according to an embodiment of the invention.

Method 100 may include the following stages:
a. Receiving or building multiple investment portfolios. Each investment portfolio may exhibit multiple characteristics. (S 110).
b. Receiving or generating information about a large number of investment opportunities; wherein each investment opportunity exhibits investment characteristics and is formed from a financial asset (S 120). Stage 120 may include determining whether a financial asset should be considered to be included in (or be part of) an investment opportunity. The generation of information may include calculating characteristics of the large number of the investment opportunities. The characteristics of an investment opportunity can be updated once the financial asset that forms the investment opportunity is included in an investment portfolio. For example, the method may include calculating at least one characteristic of a financial asset in response to an investment portfolio that includes the financial asset. One or more characteristics of the investment opportunity can be calculated based upon one or more characteristics of one or more investment portfolios (for example—risk level of investment portfolio) while one or more other characteristic of the investment opportunity can be calculated in response to external information (for example—volume of financial assets, price of financial asset). It is noted that an investment opportunity may be formed from multiple financial assets. One or more characteristic of a financial asset (minimal price, allowed date of purchase) can be used to determine whether the financial asset should be considered to be included in (or be part of) an investment opportunity.
c. Comparing in real time, by the computerized system, between characteristics of investment opportunities and characteristics of a large amount of investment portfolios to find investment opportunities that match investment portfolios. (S 130).
d. Adding or removing financial assets from the investment portfolios at least partially in response to the results of the comparison. (S 140).
e. The adding or removing may include adding investment opportunities to investment portfolios that match the investment opportunities. (S 141).
f. The adding or removing may include adding an investment opportunity to an investment portfolio if the investment portfolio has available cash to purchase the financial asset that forms the investment opportunity (S 142).
g. The adding or removing may include adding an investment opportunity to an investment portfolio if the investment portfolio has a financial asset that is less attractive than the financial asset that forms the investment opportunity (S 143).
h. The adding or removing may include constantly monitoring characteristics of financial assets that form the investment portfolios (S 144).
i. The adding or removing may include monitoring characteristics of financial assets that belong to investment portfolios and removing financial assets from investment profiles if it is detected that characteristics of the financial assets changed and do not match the characteristics of the investment profiles. (S 145)
j. The adding or removing may include evaluating a profit loss ratios of financial assets that belong to investment portfolios and of financial assets that form investment opportunities and replacing a first financial asset that belongs to an investment portfolio by a second financial asset that forms an investment opportunities if a profit loss ratio of the first financial asses is lower than a profit loss ratio of the second financial asset by at least a predetermined amount. (S 146).
k. Managing the investment portfolios based upon (at least partially) upon the results of the comparison (S 150).
l. The managing may include generating aggregate purchase orders, each aggregate purchase order is for purchasing financial assets required for multiple investment portfolios that include the financial asset; receiving the multiple financial assets; and splitting the multiple financial assets between the multiple investment portfolios (S 151).
m. The managing of the investment portfolios may include determining an amount of financial assets transactions based upon characteristics of the investment portfolios. (S 152).
n. The managing may include deploying a leverage option provided by a broker. (S 153). The deployment may be allowed/maintained stopped/in response level of at least one financial asset (the at least one financial asset can include the entire portfolio, one or more sectors, one or more subsectors, one or more segments).
o. Calculating a risk level of at least one financial asset by multiplying a risk factor of the at least one financial asset by a leverage factor of the at least one financial asset (S 154).
p. Managing leverage utilization in response to risk factors calculated during stage 154 (S155).
q. Determining whether to add an investment opportunity to one or more portfolios

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A computerized method for managing investment portfolios, the method comprises:
receiving by a computerized system information about a large number of investment opportunities; wherein each investment opportunity exhibits investment characteristics and is formed from a financial asset;
comparing in real time, by the computerized system, between characteristics of investment opportunities and characteristics of a large amount of investment portfolios to find investment opportunities that match investment portfolios; and
adding investment opportunities to investment portfolios that match the investment opportunities.

2. The computerized method according to claim 1, wherein the managing of the investment portfolios comprises determining an amount of financial assets transactions based upon characteristics of the investment portfolio.

3. The computerized method according to claim 1, comprising adding an investment opportunity to an investment portfolio if the investment portfolio has available cash to purchase the financial asset that forms the investment opportunity.

4. The computerized method according to claim 1, comprising adding an investment opportunity to an investment portfolio if the investment portfolio has a financial asset that is less attractive than the financial asset that forms the investment opportunity.

5. The computerized method according to claim 1, comprising constantly monitoring characteristics of financial assets that form the investment portfolios.

6. The computerized method according to claim 1, comprising monitoring characteristics of financial assets that belong to investment portfolios and removing financial assets from investment profiles if it is detected that characteristics of the financial assets changed and do not match the characteristics of the investment profiles.

7. The computerized method according to claim 1, comprising generating aggregate purchase orders, each aggregate purchase order is for purchasing financial assets required for multiple investment portfolios that include the financial asset; receiving the multiple financial assets; and splitting the multiple financial assets between the multiple investment portfolios.

8. The computerized method according to claim 1, comprising calculating at least one characteristic of a financial asset in response to an investment portfolio that includes the financial asset.

9. The computerized method according to claim 1, comprising evaluating a profit loss ratios of financial assets that belong to investment portfolios and of financial assets that form investment opportunities and replacing a first financial asset that belongs to an investment portfolio by a second financial asset that forms an investment opportunities if a profit loss ratio of the first financial asses is lower than a profit loss ratio of the second financial asset by at least a predetermined amount.

10. The computerized method according to claim 1, comprising deploying a leverage option provided by a broker.

11. The computerized method according to claim 1 comprising finding financial assets to be included in financial assets.

12. A non-transitory computer readable medium that stores instructions for:
receiving by a computerized system information about a large number of investment opportunities; wherein each investment opportunity exhibits investment characteristics and is formed from a financial asset; comparing in real time, by the computerized system, between characteristics of investment opportunities and characteristics of a large amount of investment portfolios to find investment opportunities that match investment portfolios; and adding investment opportunities to investment portfolios that match the investment opportunities.

13. The non-transitory computer readable medium according to claim 12 that stores instructions for determining an amount of financial assets transactions based upon characteristics of the investment portfolio.

14. The non-transitory computer readable medium according to claim 12 that stores instructions for adding an investment opportunity to an investment portfolio if the investment portfolio has available cash to purchase the financial asset that forms the investment opportunity.

15. The non-transitory computer readable medium according to claim 12 that stores instructions for adding an investment opportunity to an investment portfolio if the investment portfolio has a financial asset that is less attractive than the financial asset that forms the investment opportunity.

16. The non-transitory computer readable medium according to claim 12 that stores instructions for constantly monitoring characteristics of financial assets that form the investment portfolios.

17. The non-transitory computer readable medium according to claim 12 that stores instructions for monitoring characteristics of financial assets that belong to investment portfolios and removing financial assets from investment profiles if it is detected that characteristics of the financial assets changed and do not match the characteristics of the investment profiles.

18. The non-transitory computer readable medium according to claim 12 that stores instructions for generating aggregate purchase orders, each aggregate purchase order is for purchasing financial assets required for multiple investment portfolios that include the financial asset; receiving the multiple financial assets; and splitting the multiple financial assets between the multiple investment portfolios.

19. The non-transitory computer readable medium according to claim 12 that stores instructions for calculating at least one characteristic of a financial asset in response to an investment portfolio that includes the financial asset.

20. The non-transitory computer readable medium according to claim 12 that stores instructions for finding financial assets to be included in financial assets.
